(19) United States
(12) Patent Application Publication
(10) Pub. No.: US 2023/0159046 A1
(43) Pub. Date: May 25, 2023

(54) Generation and Presentation of Stimuli

(71) Applicant: ADAM COGTECH LTD, Beit Yehoshua (IL)

(72) Inventors: Erez Aluf, Beit Yehoshua (IL); Lidror Troyansky, Givataim (IL)

(21) Appl. No.: 17/995,391

(22) PCT Filed: Mar. 29, 2021
(86) PCT No.: PCT/IL2021/050352

§ 371 Date: Oct. 3, 2022

Related U.S. Application Data
(60) Provisional application No. 63/005,509, filed on Apr. 6, 2020.

(51) Int. Cl. B60W 50/14; B60W 30/095; B60W 40/08; B60K 35/00

(52) U.S. Cl. CPC B60W 50/14; B60W 30/0956; B60W 40/08; B60K 35/00; B60W 2050/146; B60W 2040/0818; B60W 2540/225; B60W 2540/229; B60K 2370/178; B60K 2370/1868; B60K 2370/194; B60K 2370/785

(57) ABSTRACT

A method, system and product including identifying, based on sensor information, a hazard in an environment of a user; determining a risk level of the hazard to the user, determining, based on the risk level, a stimuli configuration for presenting stimuli to the user, wherein the stimuli configuration defines a vector of notion having a location and a direction, wherein the location and the direction are determined based on a relative location of the hazard with respect to the user, wherein attributes of the stimuli are determined based on the risk level; and implementing the stimuli configuration, wherein said implementing comprises presenting the stimuli to the user.

### CROSS-REFERENCE TO RELATED APPLICATION

This application claims the benefit of Provisional Patent Application No. 63/005,509, titled “A System And Method For Presenting Information To Drivers”, filed Apr. 6, 2020, which is hereby incorporated by reference in its entirety without giving rise to disavowment.

### TECHNICAL FIELD

The present disclosure relates to stimuli presentation in general, and to generating and presenting stimuli that is configured to draw an attention of a user to a hazard, in particular.

### BACKGROUND

Car accidents are responsible for a substantial fraction of morbidity and mortality in the modern world.

Human factors are a major cause of such car accidents. A large number of car accidents stem from the fact that, in many cases, drivers do not have the capabilities that are required for an effective driving: Some of the human factors are related to cognitive state that can reduce driving capability, such as drowsiness, fatigue, alcohol intoxication, drug effects, acute psychological stress, emotional distress, temporary distraction, and the like. Son of the human factors are related to a focus of the driver, which may direct his attention to a certain location and ignore other locations with road hazards. Such human factors may reduce the ability of the driver to overcome road hazards.

### BRIEF SUMMARY

One exemplary embodiment of the disclosed subject matter is a method comprising: based on sensor information, identifying a hazard in an environment of a user, determining a risk level of the hazard to the user, based on the risk level, determining a stimuli configuration for presenting stimuli to the user, wherein the stimuli configuration defines a vector of motion having a location and a direction, wherein the location and the direction are determined based on a relative location of the hazard with respect to the user, wherein attributes of the stimuli are determined based on the risk level; and implementing the stimuli configuration, wherein said implementing comprises presenting the stimuli to the user.

Optionally, the user is a driver of a vehicle, wherein the sensor information is obtained from sensors of the vehicle, wherein the risk level indicates a probability of an accident of the vehicle in view of the hazard.

Optionally, one or more objects in the environment of the user separate between the vector of motion and the hazard.

Optionally, the one or more objects comprise at least one car.

Optionally, the vector of motion comprises an array of lit dots or lit lines.

Optionally, the sensor information is obtained from sensors that are configured to monitor the user, wherein said determining the risk level of the hazard is performed based on information obtained by monitoring the user.

Optionally, the method comprises monitoring a focus of attention of the user, and wherein said determining the stimuli configuration is further based on the focus of attention of the user.

Optionally, the method comprises determining that the focus of attention of the user is directed to a focus location in a windshield; and wherein the location of the stimuli is determined also based on the focus location in the windshield.

Optionally, the method comprises monitoring the user during sail implementing the stimuli configuration; and in response to identifying that said implementing has failed to induce a desired response from the user, adjusting the stimuli configuration to increase a saliency of the stimuli, and re-implementing the adjusted stimuli.

Optionally, the method comprises detecting a field of view of the user, whereby determining a peripheral visual field of the user; wherein the attributes of the stimuli are determined based on whether the hazard is located at the peripheral visual field.

Optionally, the method comprises detecting a field of view of the user, wherein the field of view comprises a first visual field from which the hazard cannot be perceived; and presenting an additional stimuli that can be perceived by the user in the first visual flied, wherein the additional stimuli is configured to direct attention of the user to a second visual field, wherein the vector of motion can be perceived in the second visual field.

Optionally, the method comprises adjusting the risk level of the hazard to a second risk level, wherein the second risk level is different from the risk level; in response to said adjusting, determining a second stimuli configuration for presenting the stimuli to the user, wherein the second stimuli configuration is different from the stimuli configuration; and implementing the second stimuli configuration.

Optionally, the method comprises determining a second risk level of a second hazard, wherein the risk level is different from the second risk level; and in response to said determining the second risk level, determining a second stimuli configuration for presenting a second stimuli to the user, wherein the second stimuli configuration is different from the stimuli configuration.

Optionally, the stimuli configuration defines a second vector of motion that has a second direction, wherein the direction of the vector of motion and the second direction of the second vector of motion converge to an estimated location of the hazard.

Optionally, a first distance between the vector of motion and the hazard is different from a second distance between the second vector of motion and the hazard.

Optionally, the stimuli configuration is not configured to present the stimuli in more than three sides of the hazard.

Optionally, the attributes of the stimuli comprise a duration of presenting the stimuli; a size of the stimuli; a color of the stimuli; a saliency of the stimuli; a transparency level of the stimuli; a speed of motion of the stimuli; a length of the vector of motion; a distance between the stimuli and the hazard; a position of the stimuli, or the like.

Another exemplary embodiment of the disclosed subject matter is a computer program product comprising a non-transitory computer readable storage medium retaining program instructions, which program instructions when read by a processor, cause the processor to: based on sensor information, identify a hazard in an environment of a user; determine a risk level of the hazard to the user; based on the risk level, determine a stimuli configuration for presenting stimuli to the user, wherein the stimuli configuration defines a vector of motion having a location and a direction, wherein the location and the direction are determined based on a relative location of the hazard with respect to the user, wherein attributes of the stimuli are determined based on the risk level; and implement the stimuli configuration, wherein said implement comprises presenting the stimuli to the user.

Yet another exemplary embodiment of the disclosed subject matter is a system comprising a processor and coupled memory, the processor being adapted to: based on sensor information, identify a hazard in an environment of a user; determine a risk level of the hazard to the user, based on the risk level, determine a stimuli configuration for presenting stimuli to the user, wherein the stimuli configuration defines a vector of motion having a location and a direction, wherein the location and the direction are determined based on a relative location of the hazard with respect to the user, wherein attributes of the stimuli are determined based on the risk level; and implement the stimuli configuration, wherein sail implement comprises presenting the stimuli to the user.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an exemplary environment in which the disclosed subject matter may be utilized, in accordance with some exemplary embodiments of the disclosed subject matter,

FIG. 2 shows an exemplary flowchart diagram of a method, in accordance with some exemplary embodiments of the disclosed subject matter:

FIG. 3 shows an exemplary stimuli configuration, in accordance with some exemplary embodiments of the disclosed subject matter;

FIG. 4 shows an exemplary stimuli configuration, in accordance with some exemplary embodiments of the disclosed subject matter,

FIG. 5 shows an exemplary stimuli configuration, in accordance with some exemplary embodiments of the disclosed subject matter,

FIG. 6 shows an exemplary stimuli configuration, in accordance with some exemplary embodiments of the disclosed subject matter,

FIG. 7 shows an exemplary stimuli configuration, in accordance with some exemplary embodiments of the disclosed subject matter,

FIG. 8 shows an exemplary stimuli configuration, in accordance with some exemplary embodiments of the disclosed subject matter, and

FIG. 9 shows a block diagram of an apparatus, in accordance with some exemplary embodiments of the disclosed subject matter.

### DETAILED DESCRIPTION

One technical problem dealt with by the disclosed subject matter is presenting hazard-related information to users, e.g., in an efficient and user-friendly manner. In some exemplary embodiments, the term “user” may relate to a driver of a vehicle, an observer of a screen or scene, or any other user to which stimuli can be presented. In some exemplary embodiments, hazard-related information may include information that indicates potential hazards such as road hazards, essential information, safety-related information that indicates potential threats, or the like. In some exemplary embodiments, hazards, potential threats, or other objects in the environment of a user may be referred to hereinafter as “hazards”. It is noted that while the disclosed subject matter is explained with respect mainly to road hazards, the disclosed subject matter is not limited to such hazards and may relate to any form of information in the scene to which the attention of the user is to be directed.

A large number of car accidents stem from the fact that, in many cases, the drivers lack the required information regarding potential threats and hazards. Additionally, obtaining the required information may require drivers to shift their attention from the road, which presents an additional complication. In some exemplary embodiments, the prevalence of Advanced Driver-Assistance Systems (ADAS) systems and semi-autonomous cars, which may encourage drivers to trust the safety system and to be engaged in other activities while driving, may further expand the scope of the problem, as drivers may be required to abruptly shift their attention to the road and to quickly process the required information in order to provide an adaptive response during a very short period of time. It may be desired to assist the user with obtaining the required hazard-related information in an efficient and swift manner.

Another technical problem deal with by the disclosed subject matter is drawing the attention of a driver or another observer to a road hazard. e.g., without flooding the user with potentially confusing information. It may be desired to enable the user to swiftly draw her attention to road hazards, thereby obtaining the hazard-related information, while preventing her from being overwhelmed with data.

Yet another technical problem dealt with by the disclosed subject matter is providing hazard-related stimuli to a user without requiring the user to purchase expensive accessories or wear them. In some exemplary embodiments, projecting al the required information or alerting the driver using audible stimuli and icons that represent the type of hazard whenever an ADAS system deems that there is a potential risk, may, in most cases, overwhelm the user with too much information, require the user to wear additional accessories, may be expensive, or the like. It may be desired to overcome such drawbacks. For example, it may be desired to provide a system of presenting safety information to drivers that does not overwhelm the driver and does not require to wear or purchase accessories.

One technical solution of the disclosed subject matter is to present hazard-related information to users by drawing the attention of the users to identified hazards. In some exemplary embodiments, the hazard-related information may be presented to users, e.g., in order to point out threats or hazards, to draw their attention to occurring threats, to focus drivers' attention to relevant locations and directions, or the like, e.g., in the peripheral visual field of a user or in any other location that is not viewed by the user altogether. In some exemplary embodiments, in order to draw a user's attention to a hazard, one or more arrays of visual stimuli may be generated and presented to the user, e.g., via a windshield of a vehicle driven by the user, via a screen, a platform, or the like. For example, the visual stimuli may be used for creating an illusion of motion by projecting on the windshield arrays of lit dots or lit lines. The illusion of motion may be created by creating a sequence in which different dots are lit, or different parts of the lines are lit. In some exemplary embodiments, a system of the disclosed subject matter may enable to indicate potential directions or locations of hazards and threats.

In some exemplary embodiments, the disclosed subject matter may provide different stimuli depending the focus of attention of the user. In some cases, different stimuli may be displayed in a location that is captured as part of the peripheral visual field of the driver in comparison to stimuli that is captured in the central vision, near the center of the gaze of the driver, or the like.

In some exemplary embodiments, the visual stimuli may be projected on the windshield of a vehicle. In some exemplary embodiments, the stimuli may be displayed on a platform such as an instrument cluster, a steering wheel; a head up display; a vehicle mirror; a vehicle sun visor, a centre console, or the like. In other cases, the information may be displayed on any other component or using any other device. In some exemplary embodiments, the term “windshield” as used hereinafter may be replaced with any other screen or platform that may enable to present stimuli thereon.

In some cases, the visual stimuli may be presented by a reflection of light from a light source, by direct light, by projecting light on the windshield, by radiating laser light on windshield glass that may be laser etched with non-visible fine lines, using full windshield display (FWD) that utilizes a polarized windshield that reflects projected lights, or by any other presenting technique that can be utilized to present stimuli to the driver or to any other user. Alternatively, the visual stimuli may be presented via eyeglasses with augmented reality application. For example, the disclosed subject matter may be implemented in a vehicle of the driver by utilizing a windshield of the vehicle as the display on which stimuli can be projected, utilizing sensors located in the vehicle to identify hazards, utilizing internal sensors to track the user's state or attention focus, utilizing light sensors to project the stimuli on the windshield, or the like.

In some exemplary embodiments, the disclosed subject matter may be configured to direct an attention of a user to a determined direction. e.g., to a direction of a hazard, to a determined location of the hazard, or the like. In some exemplary embodiments, instead of displaying explicit endogenous data, such as by encircling the hazard, the stimuli may be configured to draw the user's attention implicitly to the direction or location of the hazard, thereby utilizing exogenous stimuli. In some exemplary embodiments, exogenous stimuli may be more intuitive than endogenous stimuli, and may enable to automatically direct the user's attention to the desired location without conscious intention. Such operation may cause the desired effect faster than utilizing endogenous stimuli which may require additional processing by the user's brain.

In some exemplary embodiments, the visual stimuli may be presented in various arrays of dots, arrays of lines, or in any other shape or form. In some exemplary embodiments, the visual stimuli may comprise or consist of one or more patterns such as one or more vectors of perceived motion, one or more sequences of shapes, or the like, that may form one or more stimuli motions directing the user to a direction of an identified hazard. In some exemplary embodiments, the stimuli may comprise or consist of an array of light dots or light lines that moves continuously in time, that has altering levels of brightness, that has altering levels of size, or the like, e.g., thereby inducing a vector of perceived motion. In some exemplary embodiments, inducing a vector of perceived motion may provide the user exogenous stimuli that is intuitive, and may enhance an affect, response time and a success rate of the stimuli. In some cases, the stimuli that is generated may or may not be seamless or barely seamless. In some exemplary embodiments, the stimuli may comprise a gradient pattern such as of light dots in a decreasing or increasing size. In some exemplary embodiments, decreasing or increasing the size of the dots may enhance a perceived motion of the hazard away from the user or towards the user, respectively.

In some exemplary embodiments, the stimuli may be utilized to actively direct and influence the focus of attention of the user, actively encouraging the user to look to a certain direction or focus location. For example, the user's attention may be directed to a different location than her current gaze. As another example, the user's attention may be directed to a location that was previously in the peripheral visual field of the user or in a location not visible to the user in view of the direction of her gaze. In some exemplary embodiments, one or more attributes of the stimuli may be configured for this purpose. In some exemplary embodiments, in some cases, multiple stimuli arrays may be used to indicate a specific location of the hazard in addition to its direction, e.g., by directing the user to two or more directions that overlap or converge in the location of the hazard. In some exemplary embodiments, the stimuli may be displayed for a very short duration (e.g., 100 milliseconds or the like), or for longer durations. In some exemplary embodiments, the length of displaying the stimuli may be determined based on a type of detected hazard, based on attributes of the determined scenario, based on user attributes, based on a relative position between the user's gaze and the hazard, or the like. In some exemplary embodiments, additional parameters of the stimuli such as the size of the stimuli patterns, the variation in size of the stimuli, the color of the stimuli, the position of the stimuli, the saliency of the stimuli, the transparency level of the stimuli, the lighting intensity of the stimuli compared to the environment lighting, the speed of motion of the stimuli, or the like, may be determined based on a type of a detected hazard, based on attributes of the determined scenario, based on user attributes, based on a detected cognitive state of the user, or the like.

In some exemplary embodiments, presented stimulus may be created or generated based on user-specific data that was accumulated during previous engagements of stimuli with the user, based on a baseline of users that may be similar to the user, such as users with similar profile, similar physical attributes, similar demographic attributes, similar observed behavior, or the like, based on a general baseline of drivers. e.g., relating to a length of the drive which may influence drivers, to a speed of driving which may influence drivers, or the like. In some exemplary embodiments, a system incorporating the disclosed subject matter may be personally tailored to a user. e.g., by taking into account user data such as the user's physical condition in general (e.g. which may be indicated at least in part by age, acuity of sight, or the like), the user's physical condition at a specific timeframe (e.g. a level of fatigue, a level of alertness, an identified mood, identified distractions, or the like), the dynamics of ongoing attention allocation, or the like. In some cases, parameters of the stimuli such as its color, its intensity, is duration, or the like, may be adjusted per driver. e.g., as described International Application Publication No. WO 2019/186560, filed “Cognitive state-based seamless stimuli”, which is hereby incorporated by reference in is entirety for all purposes and without giving rise to disavowment. In some exemplary embodiments, a personalized machine learning or artificial intelligence module, e.g., utilizing a reinforcement learning paradigm or supervised learning, may be used in order to reduce the gap between the predicted focus of attention of a user and the required focus of attention of the user, and to learn the most effective set of stimuli that would enhance the focus of attention of the user to meet the required focus. In some exemplary embodiments, the personalized module may be configured to identify attributes of stimuli that are affective for a specific user, and a context in which stimuli attributes are affective.

In some exemplary embodiments, presented stimulus may be created or generated based on sensor data. In some exemplary embodiments, internal sensors may monitor the user. e.g., track the user's eyes, in order to identify the user's state of mind, the user's attention focus, or the like. In some exemplary embodiments, the stimuli may be generated to match the user's attention focus or level of attention. For example, the identified user's attention focus may influence the location of the windshield in which the stimulus is presented. e.g., by ensuring the stimuli is visible in the user's field of view. In some exemplary embodiments, the response of the user to presented stimuli may be detected, and in case the stimuli are determined to be ineffective, the saliency of the stimuli may be amplified. In some exemplary embodiments, external sensors may monitor the environment surrounding the user, e.g., cars in the environment, in order to identify one or more dangers, hazards, objects, changes in attributes of a hazard such as a modified location, or the like. In some exemplary embodiments, the stimuli may be generated to match the detected hazards in the environment.

One technical effect of the disclosed subject matter is managing the user's attention in an enhanced and effective manner. In some exemplary embodiments, implementing the disclosed subject matter enables to present potential directions of hazards and threats in a manner that minimizes the disturbance to the driver, while allowing for a timely and adaptive response of the driver to threats and/or hazards. The disclosed subject matter avoids from overwhelming the visual field of the user with excessive data and/or explicit endogenous data, and instead directs the user's attention to important hazards while retaining a clean and non-noisy environment.

Another technical effect of the disclosed subject matter is to provide exogenous stimuli that is useful for effectively and efficiently directing the user's attention. Additionally or alternatively, the stimuli may be designed to reduce alert fatigue as it may not require conscious intention to be processed to induce a response. Additionally or alternatively, the stimuli may cause a reduced alert fatigue effect in comparison to corresponding endogenous stimuli.

Yet another technical effect of the disclosed subject matter is enabling to utilize the user's peripheral vision for drawing her attention. In some exemplary embodiments, as peripheral vision may be sensitive to motion, the disclosed subject matter utilizes this sensitivity when presenting the stimuli to the user in the peripheral visual field of the windshield. In some exemplary embodiments, by utilizing the sensitivity of the peripheral vision to motion, the disclosed subject matter utilizes a large part of the visual field of a driver that otherwise remains substantially unutilized.

The disclosed subject matter may provide for one or more technical improvements over any pre-existing technique and any technique that has previously become routine or conventional in the an. Additional technical problem, solution and effects may be apparent to a person of ordinary skill in the art in view of the present disclosure.

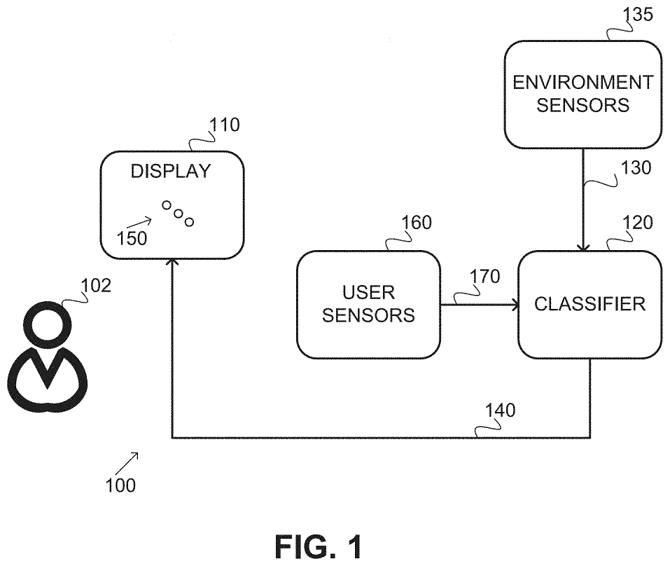

Referring now to FIG. 1 showing an illustration of an exemplary environment, in accordance with some exemplary embodiments of the disclosed subject matter.

In some exemplary embodiments. Environment 100 may comprise a Display 110. In some exemplary embodiments, Display 110 may be presented on a windshield of a vehicle, on a different component of a vehicle, on a screen, or on any other platform that can be used to present or display stimuli to a User 102. As another example, Display 110 may be part of a wearable device, such as but not limited to augmented reality glasses, personal projector, or the like. In some exemplary embodiments, User 102 may be a driver or any other user, operator, or the like. In some exemplary embodiments, the Display 110 may be operable to present stimuli to User 102, in a manner that is configured to draw the user's attention to hazards, threats, or the like, without disturbing or overwhelming the User 102 with excessive or endogenous data. In some exemplary embodiments, Display 110 may enable to present to the User 102 stimuli in the form of hints or indications regarding the direction of one or more hazards, a location of a hazard, or the like.

In some exemplary embodiments, Environment 100 may comprise a Classifier 120. In son exemplary embodiments, Classifier 120 may comprise one or more Artificial Intelligence (AI) classifiers, Machine Learning (ML) classifiers, Deep Learning (DL) classifiers, computer vision classifiers, data-driven classifiers, heuristics-based classifiers, or any other type of predictor or classifier.

In some exemplary embodiments. Environment 100 may comprise one or more sensors such as Environment Sensors 135, User Sensors 160, or the like. In some exemplary embodiments. Classifier 120 may be configured to obtain Sensor Data 130 from Environment Sensors 135, Sensor Data 170 from User Sensors 160, or the like. In some exemplary embodiments. Classifier 120 may be configured to determine, based on obtained sensor data, risk scores to hazards that can be perceived via Display 110. e.g., via a windshield of a car. In some exemplary embodiments. Classifier 120 may determine risk scores for hazards by utilizing Sensor Data 130. Sensor Data 170, data from sensors that monitor the environment of User 102, data from sensors that assess a cognitive state of User 102, manually inputted data, or the like. In some exemplary embodiments, in addition to utilizing environmental data such as Sensor Data 130 from an environment of User 102, e.g., outside a vehicle that User 102 may be driving, the Classifier 120 may also utilize internal data such as Sensor Data 170 from inside the vehicle, such as from driver-monitoring sensors, from an eye-tracker, a microphone (not illustrated), a driver-facing camera (not illustrated), or the like.

In some exemplary embodiments, the visual Stimuli 150 may include a refection of light emitters such as Light Emitting Diodes (LEDs) that may be located below the windshield of Display 110, on the windshield. In some exemplary embodiments, high brightness LED arrays may be mounted on a top surface of the Instrument Panel (IP) of a vehicle and may be reflected though the windshield. In some exemplary embodiments, an array of micro LEDs may be embedded into the windshield, thereby allowing to present visual cues directly on the windshield. In some cases. Full Windshield Head-Up Display (FW-HUDs) techniques may be used in order to present the information on the windshield. In other cases, any other technique may be used to present information on the windshield. In some cases. Digital Light Projection (DLP) techniques may be used for projecting the essential information on parts of the windshield. In other cases, any other technique may be used to project information on the windshield or on any other component or device.

In some exemplary embodiments, the Display 110 may be adjusted according to a risk associated with each hazard, as may be deemed by Classifier 120. In some exemplary embodiments, adjusting the Display 110 may comprise adding at least some Stimuli 150 thereto, removing at least some Stimuli 150 therefrom, modifying a visual appearance of Stimuli 150, modifying a saliency level of Stimuli 150, modifying a position of Stimuli 150 within Display 110, modifying a size or color of Stimuli 150, modifying a speed of motion of Stimuli 150, modifying a number of arrays of Stimuli 150, or the like. In some exemplary embodiments, the internal data such as Sensor Data 170 from within the vehicle, may be utilized in order to adjust the parameters of Stimuli 150 according to the responses of the user, an attention level of the user, a cognitive state of the user, or the like, thereby allowing a smooth stimuli escalation with a minimal undue disturbance to the drivers. In some exemplary embodiments, the environmental data such as Sensor Data 130 from within the vehicle may be utilized in order to adjust the parameters of Stimuli 150 according to the changes in the surrounding environment of User 102.

In some exemplary embodiments, a classifier such as Classifier 120 may be utilized to estimate an advantageous adjustment of the Display 110, e.g., based on a profile of the User 102. In some exemplary embodiments, a saliency level of the presented Stimuli 150 may be determined by the Classifier 120 based on event factors such as a risk level of the threat, a required response time, a type of the required response, a speed of the threat, an urgency of the situation, a vigilance level of the driver as determined from previous responses, or the like. In some exemplary embodiments, Stimuli 150 may be presented to User 102 via an Output 140 from Classifier 120 in a manner that conveys information regarding the event factors, e.g., by adjusting one or more attributes of Stimuli 150 such as a color of Stimuli 150 (e.g., using a color scheme such as red, yellow and green), a type of stimuli (e.g., lines, dots, arrows, or the like), a light frequency of Stimuli 150, a speed of motion of Stimuli 150, a size of Stimuli 150, a saliency level of Stimuli 150, or the like. In some exemplary embodiments, the saliency level of the presented Stimuli 150 may reflect an urgency level of the threat. In some exemplary embodiments, the Classifier 120 may utilize methods described in International Application Publication No. WO 2019/186560, titled “Cognitive state-based seamless stimuli”, in order to determine a saliency level of the presented Stimuli 150, or to determine other characteristics of the stimuli.

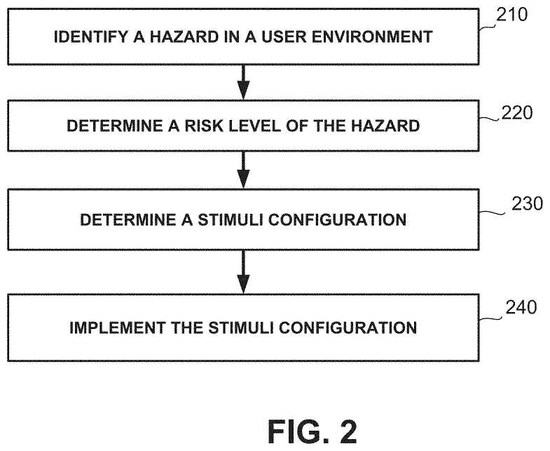

Referring now to FIG. 2, illustrating an exemplary method, in accordance with some exemplary embodiments of the disclosed subject matter.

On step 210, one or more hazards in an environment of a user may be identified, e.g., based on sensor information. In some exemplary embodiments, a hazard may include a car, a road disturbance, or the like, which may be detected by one or more sensors monitoring the environment of the user. In some exemplary embodiments, in some cases, the user may be a driver of a vehicle, and the sensor information may be obtained from sensors of the vehicle, sensors mounted on the vehicle, or the like. In some exemplary embodiments, the sensor information may be obtained from sensors that are configured to monitor the user, sensors that are configured to monitor the environment of the user, or the like. In some exemplary embodiments, the hazard may be identified by a classifier, such as based on environmental sensor data from environmental sensors.

On step 220, a risk level of a hazard to the user may be determined. In some exemplary embodiments, the risk level may indicate a probability of an accident of the vehicle. e.g., in view of the hazard. In some cases, the accident may include a crash or collision between the vehicle and the hazard, a crash of the vehicle with a different object that may be caused by the hazard, a crash between the hazard and a different object that may be caused by the vehicle, or the like. For example, the hazard may include a cat standing in the road, and a potential crash may be caused in case the user tries to avoid the cat and crashes into a wall instead. In some exemplary embodiments, in case of a high probability of an accident that overpasses a risk threshold, a high risk level may be determined, while in case of a low probability of an accident below a risk threshold, a low risk level may be determined. In some cases, hazards with low risk levels may be disregarded, dismissed, overlooked, ignored, or the like, and Step 230-240 may not be performed. In some exemplary embodiments, a user may configure a desired level of risk for which stimuli presentation is desired.

In some exemplary embodiments, the risk level may be determined based on the attributes of the hazard, such as based on a probability of a collision of a vehicle of the user with the hazard or with any other object. In some exemplary embodiments, attributes of the hazard may be determined based on sensor information monitoring the environment of the user. In some exemplary embodiments, the attributes may include a direction of movement of the hazard with respect to a static or dynamic user, an urgency of noticing the hazard, an estimated timeframe until a collision of the user with the hazard or other object, a probability of an accident of a vehicle of the user, or the like.

In some exemplary embodiments, the risk level may be determined based on the attributes of the user, such as based on a focus of attention of the user. For example, in case the focus of attention of the user is directed to a car crash on the left side of the road, the user may be determined to have a high probability of a collision with a hazard on the right side of the road, the hazard be assigned a high risk level. In some exemplary embodiments, the attributes of the user may be determined based on sensor information that may be obtained from sensors that are configured to monitor the user.

On step 230, based on the risk level, a stimuli configuration for presenting stimuli to the user may be determined. In some exemplary embodiments, the stimuli configuration may define a vector of motion having a location and a direction. e.g., on the windshield. In some exemplary embodiments, the location and direction of the vector of motion may be determined based on a relative location of the hazard with respect to the user. In some exemplary embodiments, the location and direction of the vector of notion may be configured to draw the user's attention to the hazard. In some exemplary embodiments, the vector of notion may provide a direction of the hazard with respect to the user, such as an array of moving light dots or lines moving in the direction of the hazard. In some exemplary embodiments, the stimuli configuration for presenting information to the user may be determined based on the attributes of the hazard, an observed attention state of the user, or the like.

In some exemplary embodiments, the vector of motion may comprise an array of lights. e.g., light dots or lines, lit dots or lines, or the like, which may be presented sequentially in time, sequentially in light intensity, sequentially in color, or the like. In some exemplary embodiments, the dots or lines may create a pattern of movement in the direction of the hazard, e.g., by turning on or being presented sequentially. In some exemplary embodiments, the lights may decrease in size in the direction of the hazard's movement, thereby providing a distance indication from the hazard that may enhance a perceived effect of motion.

In some exemplary embodiments, the stimuli configuration may define a saliency level of the presented stimuli. In some exemplary embodiments, the saliency level may define how noticeable, outstanding, prominent, remarkable, or the like, the stimuli that is generated should be. In some exemplary embodiments, the saliency level may be determined based on one or more attributes or factors such as an identified risk level of the hazard, a required response time, a type of the required response, a determined vigilance level of the driver, or the like.

In some exemplary embodiments, attributes of the stimuli may be configured to match the risk level of the hazard, may be determined based on the risk level, or the like. In some exemplary embodiments, the attributes of the stimuli may comprise a duration of presenting the stimuli, a size of the stimuli, a length of the vector of motion, a color of the stimuli, a saliency of the stimuli, a transparency level of the stimuli, a speed of motion of the stimuli, a variance of sizes of stimuli shapes, a distance between the stimuli and the hazard, a position of the stimuli within a windshield of a vehicle, a light intensity of the stimuli, an amount of arrays or vectors of stimuli, a number of objects such as lit dots in each vector of motion, or the like. In some exemplary embodiments, higher risk levels may be matched to higher saliency levels of the stimuli, longer durations, larger sims, stronger colors, lower transparency levels, or the like, and vice versa.

In some exemplary embodiments, the stimuli configuration may not be configured to present the stimuli in more than three sides of the hazard. For example, in case one vector of motion is positioned below a perceived view of the hazard, a second vector of motion is positioned to the eft of a perceived view of the hazard, and a third vector of motion is positioned to the right of a perceived view of the hazard, the stimuli configuration may not generate a fourth vector of motion on top of the perceived view of the hazard. Alternatively, stimuli may be presented in any number of sides of the hazard.

In some cases, one or more objects in the environment of the user may separate between the vector of motion and the hazard. For example, at least one car may separate between the vector of motion and the hazard. In some exemplary embodiments, objects may include road hazards such as cars, road obstructions, obstacles, or any other identified object. In some cases, the vector of motion and the hazard may not be separated by an object.

In some exemplary embodiments, the stimuli configuration may define a second vector of motion that provides a second direction of the hazard. In some exemplary embodiments, the original direction of the original vector of motion and the second direction of the second vector of motion may together converge to an estimated location of the hazard. In some exemplary embodiments, any other number of additional vectors of motion may be added. In some exemplary embodiments, in some cases, a first distance between the vector of motion and the hazard may be different from a second distance between the second vector of motion and the hazard.

In some exemplary embodiments, the stimuli configuration may be determined or adjusted based on the focus of attention of the user. In some exemplary embodiments, a focus of attention of the user may be monitored. e.g., using one or more eye tracking devices. For example, in case the focus of attention of the user is determined to be directed to a focus location in a windshield, the stimuli configuration may be determined to position the stimuli that is presented via the windshield in a position that corresponds to the focus location in the windshield to which the user's focus is directed, thereby ensuring that the user can perceive the stimuli.

In some exemplary embodiments, a field of view of the user may be detected as comprising a first visual field from which the hazard cannot be perceived by the user. In some exemplary embodiments, upon identifying that the field of view comprises the first visual field, an additional stimuli or vector of motion may be generated and presented in the first visual field that can be perceived by the user. In some exemplary embodiments, the additional vector of motion may be configured to direct the attention of the user to a second visual field, from which the original vector of motion and/or the hazard can be perceived.

On step 240, the stimuli configuration may be implemented, e.g., by presenting the stimuli to the user. In some exemplary embodiments, the stimuli may be presented to the user according to the configurations defined in the stimuli configuration. In some exemplary embodiments, the stimuli may be presented using one or more presenting technologies such as using direct light projection, using reflected light, or the like. In some exemplary embodiments, the stimuli may be presented via a refection of light emitters such LEDs that may be located below the windshield, via a reflection of light emitters such high brightness LEDs that may be mounted on a top surface of the IP of a vehicle to prevent a washed out vision of the stimuli, via an array of micro LEDs that may be embedded into the windshield, via FW-HUDs techniques, via DLP techniques, a combination thereof, or using any other technique.

In some exemplary embodiments, the user may be monitored during the implementation of the stimuli configuration. In some exemplary embodiments, in response to identifying that implementing the stimuli configuration has failed to induce a desired response from the user, the stimuli configuration may be adjusted to increase a saliency of the stimuli and to re-implement the adjusted stimuli. For example, the saliency of the stimuli may be increased by increasing a light intensity of the stimuli, by increasing a size of the stimuli, or the like. In some exemplary embodiments, in response to identifying that implementing the stimuli configuration has succeeded to induce a desired response from the user, e.g. has caught the attention of the user and enabled her to response to the threat, the stimuli configuration may be adjusted to remove the stimuli.

In some exemplary embodiments, the stimuli may be configured to be presented in the peripheral visual field of view of the user, thereby drawing the user's attention to the peripheral visual field of view. In some exemplary embodiments, the stimuli may be configured to be presented in a non-peripheral visual field of view or in any other field of view. e.g., that is determined not to be perceived by the user. In some cases, a field of view of the user may be detected and analyzed to determine or identify a peripheral visual field of the user within the windshield. In some exemplary embodiments, based on whether or not the hazard is located at the peripheral visual field of view of the user, attributes of the stimuli may be adjusted accordingly, determined to be presented, or the like. In some cases, in case the hazard is not located at the peripheral visual field of view of the user, e.g., is located in the main visual field of view, such as right in front of the user, the stimuli may be configured to not to be presented. e.g., as it may be estimated to be redundant. In some cases, in case the hazard is not located at the peripheral visual field of view of the user, the stimuli may be configured to be presented, e.g., in case the user is determined not to pay attention to the hazard, in case the focus of attention of the user is not drawn to the hazard's direction, or the like.

In some exemplary embodiments, the risk level of the hazard may be adjusted to a second risk level. e.g., based on sensor information indicating a change in the environment, a change in the user's attention, or the like. In some exemplary embodiments, in response to adjusting the risk level, a second stimuli configuration for presenting the stimuli to the user may be determined. In some exemplary embodiments, the second stimuli configuration may be different from the stimuli configuration, when the risk level is different from the second risk level In some exemplary embodiments, the second stimuli configuration may be implemented, e.g., by presenting the stimuli via the windshield. For example, in response to identifying that a car that was estimated to collide with the vehicle of the user in a probability of 60% is now estimated to collide with the vehicle of the user in a probability of 90%, a second stimuli configuration with higher saliency levels may be determined and implemented.

In some exemplary embodiments, a second risk level of a second hazard may be determined, e.g., during presentation of the stimuli of the original hazard, simultaneously with identifying the original hazard, after completion of the stimuli presentation, or the like. In some exemplary embodiments, in response to determining the second risk level, a second stimuli configuration for presenting a second stimuli to the user may be determined. In some exemplary embodiments, the second stimuli configuration may be different from the stimuli configuration, in case the original or previous risk level is different from the second risk level. In some exemplary embodiments, both configurations may be implemented simultaneously, sequentially, based on a level or risk, or the like. For example, the original stimuli may be triggered for a tree hazard with a 20% probability of collision, while the second stimuli may be triggered for a car hazard with an 80% probability of collision. According to this example, the first stimuli configuration may configure stimuli that provides the direction of the tree using small vectors of motion with weak light intensity, and the second stimuli configuration may configure stimuli that provides the direction of the car using large vectors of motion with a high light intensity.

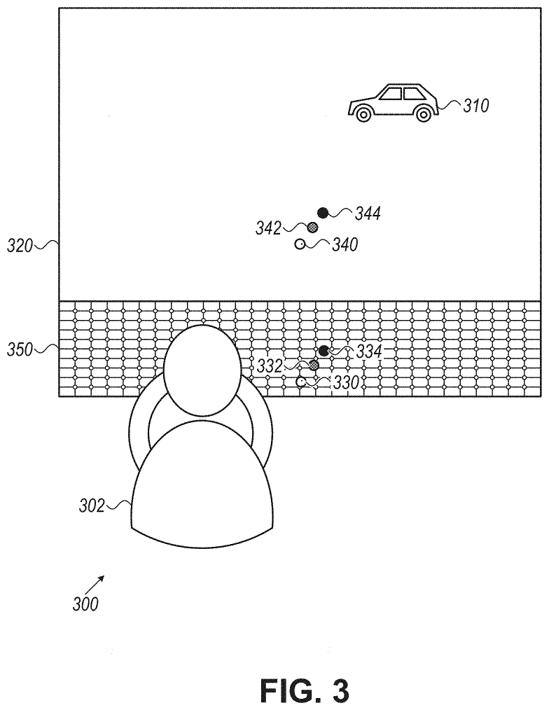

Referring now to FIG. 3, illustrating an exemplary Stimuli Configuration 300, in accordance with some exemplary embodiments of the disclosed subject matter. In some exemplary embodiments, Stimuli Configuration 300 may be configured for presenting information to User 302. e.g., via a display, a windshield, or the like.

In some exemplary embodiments. Stimuli Configuration 300 may be configured for creating an illusion of motion in the peripheral visual field of vehicle drivers, in non-peripheral visual field of vehicle drivers, or the like. As illustrated in FIG. 3, a vehicle driver such as User 302 may drive a vehicle with a Windshield 320, over which an illusion of motion may be created. In some exemplary embodiments, the illusion of motion may be created by turning-on Light Sources 330, 332 and 334 of an Array 350 of light sources one after the other. In some exemplary embodiments. Light Sources 330, 332 and 334 may be arranged in a manner operable to induce a vector of perceived motion. e.g., the stimuli. In some exemplary embodiments, the vector of perceived motion may be reflected on Windshield 320, by Reflections 340, 342 and 344, which may induce a vector of perceived motion that points to a direction of an expected hazard as can be perceived from the driver's field of view. For example, Reflections 340, 342 and 344 may point to a direction of a potential threat or hazard such as a Car 310. In some exemplary embodiments, in order to allow a creation of various vectors, the Array 350 of light sources, which may include a plurality of sources of the reflections, may be located on a surface bellow the dashboard of the vehicle.

In some exemplary embodiments, Stimuli Configuration 300 may configure each of Light Sources 330, 332 and 334 to be turned-off after the subsequent one is turned-on, in order to induce a perception that a single dot is moving in the required direction, e.g., in the direction of the hazard such as Car 310. In some exemplary embodiments, the duration and the intensity of the lights may be altered, modified, or the like, according to a monitored response of the user. In some exemplary embodiments, any other attributes of the lights such as their sire or position may be altered according to the monitored response of the user, according to changes in the perceived environment, according to attributes of the hazard, or the like.

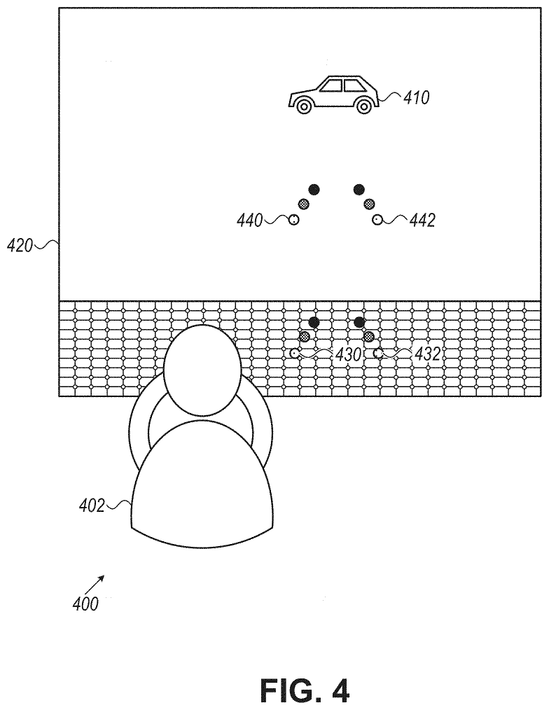

Referring now to FIG. 4, illustrating an exemplary Stimuli Configuration 400, in accordance with some exemplary embodiments of the disclosed subject matter. In some exemplary embodiments, Stimuli Configuration 400 may be configured for presenting stimuli to user, similar to Stimuli Configuration 300 (FIG. 3). FIG. 4 illustrates a scenario with multiple vectors of motion. e.g. two Vectors Of Motion 440 and 442. In some exemplary embodiments, Vectors Of Motion 440 and 442 may comprise reflections in the Windshield 420 that are produced or generated by two respective sets of Light Sources 430 and 432. In some exemplary embodiments, Light Sources 430 and 432 may be operated simultaneously in order to induce an effect of perceived notion in two simultaneous directions that converge to the assessed location of the threat in the visual field, such as Threat 410.

In some exemplary embodiments, the presented stimuli may be shaped as arrays or vectors that converge to the assessed location of the threat, or as any other shape. In some exemplary embodiments, an array or vector of stimuli may comprise one or more shapes such as a sequence of dots. e.g., presented one after each other. In some exemplary embodiments, the presented stimuli such as Vectors Of Motion 440 and 442 may remain lit until the User 402 shifts her or his attention to the threat, until a risk level of the threat is reduced, until the threat has passed, for a defined period of time, or the like. In some exemplary embodiments, Vectors of Motion 440 and 442 may comprise of dots that are located at parallel or non-parallel heights. In some exemplary embodiments, parallel dots of each Vector of Motion 440, 442 may be lit at the same time, may be turned off at the same time, or the like.

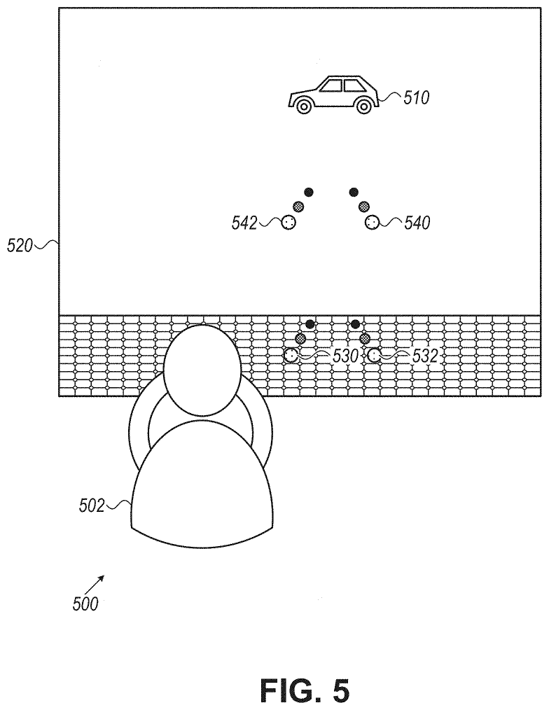

Referring now to FIG. 5, illustrating an exemplary Stimuli Configuration 500, in accordance with some exemplary embodiments of the disclosed subject matter. In some exemplary embodiments. Vectors Of Motion 540 and 542 may comprise reflections in the Windshield 520 that are produced or generated by two respective sets of Light Sources 530 and 532. In son exemplary embodiments. Stimuli Configuration 500 may configure Light Sources 530 and 532 to project light beans that create vectors of notion that decrease or increase in size, in diameter, or the like, in relation to the User 502. In some exemplary embodiments, the decreased or increased size of the light beans may affect the diameter of the respective Vectors Of Motion 540 and 542, such that reflections of light beams that are nearer the User 502 are larger in diameter than reflections of light beams that are further away from the User 502.

In some exemplary embodiments, decreasing or increasing the size of light beams from each light source according to a notion direction of the hazard may provide a movement indication of the hazard, which may enhance the perceived effect of motion. In some exemplary embodiments, the altering size of light beans from each light source nay provide a further indication of the direction of movement of the hazard with respect to the User 502.

In some exemplary embodiments, decreasing the size of each light source according to a relative distance from the User 502, as illustrated in FIG. 5, may provide for a stimuli that takes into consideration human depth perception. In some exemplary embodiments, such decreasing of sizes may enable to imitate a situation in which a threat or hazard such as Vehicle 510 is moving away from the driver, thereby enhancing the perceived effect of motion moving away from the User 502. In some exemplary embodiments. Stimuli Configuration 500 may configure Light Sources 530 and 532 to project light beams that increase in side, in diameter, or the like, in relation to the User 502. In some exemplary embodiments, increasing the size of each light source according to a relative distance from the User 502 may enable to imitate a situation in which a threat or hazard such as Vehicle 510 is moving in the direction of the driver, thereby enhancing the perceived effect of motion nearing the User 502.

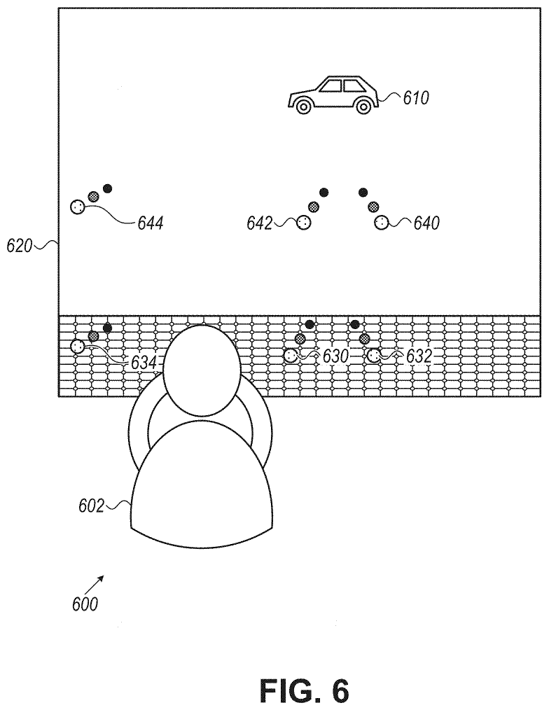

Referring now to FIG. 6, illustrating an exemplary Stimuli Configuration 600, in accordance with some exemplary embodiments of the disclosed subject matter. In some exemplary embodiments, Stimuli Configuration 600 may be configured to simultaneously present a plurality of vectors of perceived motion, for example, on more than one side of the visual field of the driver. As illustrated in FIG. 6, Light Sources 630 and 632 on the right hand side of Windshield 620 may be activated to generate Vectors Of Motion 640 and 642 as reflections in the Windshield 620. Simultaneously. Light Source 634 on the left hand side of Windshield 620 may be activated to generate Vector Of Motion 644 as a reflection in the Windshield 620. In some exemplary embodiments, activating light sources at both sides of Windshield 620 may enhance the effect on the driver, and draw her attention to Hazard 610.

For example, in the scenario of FIG. 6, a Hazard 610 is pointed out to the User 602 using two vectors of perceived motion in the right side of the driver's perceived view, as well as an additional vector of perceived motion that points to Hazard 610 in the left side of the driver's perceived view. In some cases, this may enhance an effect on the driver, for example, when the driver is looking to his left and the hazard is on his right.

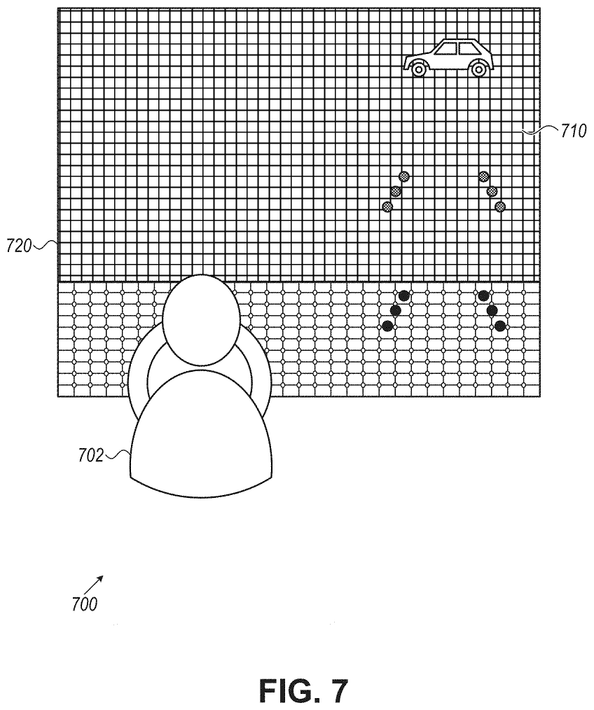

Referring now to FIG. 7, illustrating an exemplary Stimuli Configuration 700, in accordance with some exemplary embodiments of the disclosed subject matter. In some exemplary embodiments. Stimuli Configuration 700 may be implemented using a fine line engravement in Windshield 720. In some exemplary embodiments, glass of Windshield 720 may be laser etched with fine Lines 710 that are invisible to a bare human eye. In some exemplary embodiments, the engraved fine Lines 710 may become visible when illuminated by a laser light source which may be radiated from the base of the windshield, as illustrated in FIG. 7. In some exemplary embodiments, any other technique may be used to present stimuli to User 702 via Windshield 720.

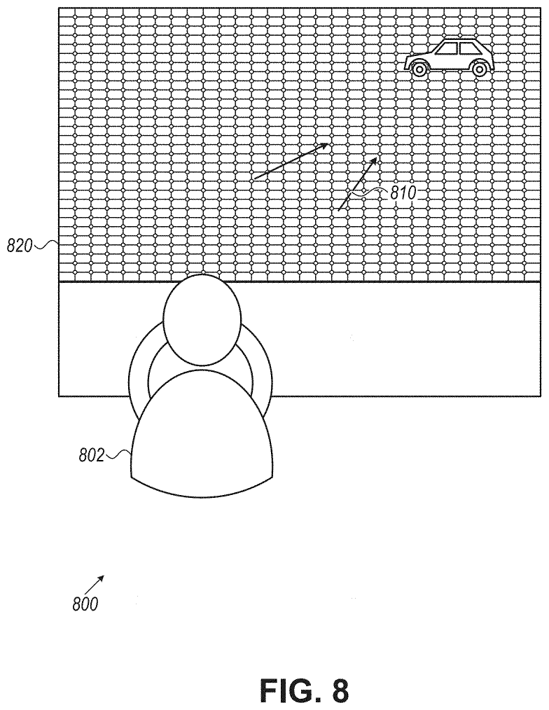

Referring now to FIG. 8, illustrating an exemplary Stimuli Configuration 800, in accordance with some exemplary embodiments of the disclosed subject matter. In some exemplary embodiments. Stimuli Configuration 800 may be configured to present stimuli using one or more techniques. In some exemplary embodiments, an array of micro-LEDs may be embedded in Windshield 820, thereby allowing to present stimuli by turning on and off the lights in the windshield. e.g., as illustrated in FIG. 8. In some exemplary embodiments, embedding LEDs into Windshield 820 may enable to present more detailed image such as replacing a vector of motion with Arrow 810. In some exemplary embodiments, arrows may provide an endogeny hint or cue, which may be less intuitive and fast in relation to the vectors of motion utilized in the previous figures, which provide an exogeny hint or cue. In some exemplary embodiments, exogenous stimuli may be more intuitive and automatically direct the user's attention to the desired location without conscious intention. In order to make the arrows more intuitive and exogenous in nature, the arrows may be presented in motion, with alerting light intensities, or the like.

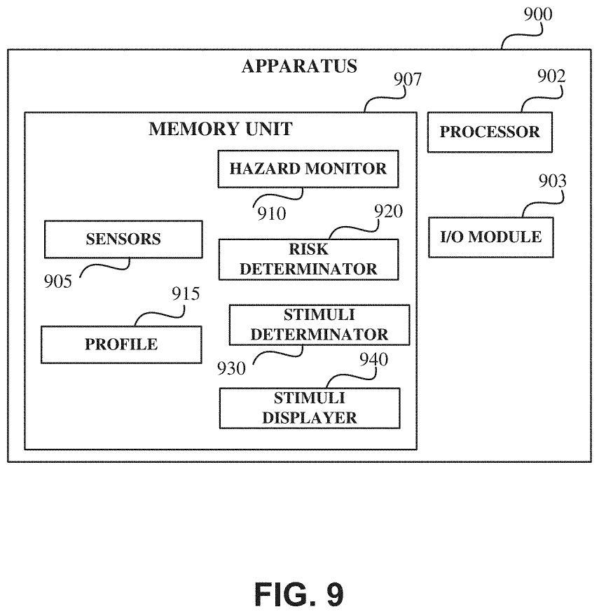

Referring now to FIG. 9 showing a block diagram of an apparatus, in accordance with some exemplary embodiments of the disclosed subject matter.

In some exemplary embodiments, an Apparatus 900 may comprise a Processor 902. Processor 902 may be a Central Processing Unit (CPU), a microprocessor, an electronic circuit, an Integrated Circuit (IC) or the like. Processor 902 may be utilized to perform computations required by Apparatus 900 or any of its subcomponents. Processor 902 may be configured to execute computer-programs useful in performing the method of FIG. 2, or the like.

In some exemplary embodiments of the disclosed subject matter, an Input/Output (I/O) Module 903 may be utilized to provide an output to and receive input from a user, to facilitate communications to and from Sensors 905, or the like. I/O Module 903 may be used to transmit and receive information to and from the user or any other apparatus, sensors, or the like, in communication therewith.

In some exemplary embodiments. Apparatus 900 may comprise a Memory Unit 907. Memory Unit 907 may be a short-term storage device or long-term storage device. Memory Unit 907 may be a persistent storage or volatile storage. Memory Unit 907 may be a disk drive, a Flash disk, a Random Access Memory (RAM), a memory chip, or the like. In some exemplary embodiments, Memory Unit 907 may retain program code operative to cause Processor 902 to perform acts associated with any of the subcomponents of Apparatus 900. In some exemplary embodiments, Memory Unit 907 may retain program code operative to cause Processor 902 to perform acts associated with any of the steps in FIG. 2, or the like.

In some exemplary embodiments. Memory Unit 907 may comprise Profile 915. In some exemplary embodiments. Profile 915 may comprise a profile of a user that indicates a cognitive state of the user, a level of affect that different types of stimuli have on the user, an effect of a context on a response of the user, or the like. In some exemplary embodiments. Profile 915 may be generated based on a history of user response to stimuli, based on a baseline of users that may be similar to the user, such as users with similar profile, similar physical attributes, similar demographic attributes, similar observed behavior, or the like, based on a general baseline of drivers, e.g., relating to a length of the drive which may influence drivers, to a speed of driving which may influence drivers, or the like. In some exemplary embodiments, Profile 915 may be obtained from a third party such as a server.

In some exemplary embodiments. Apparatus 900 may retain or communicate with Sensors 905. In some exemplary embodiments. Sensors 905 may comprise one or more sensors that are configured to track and monitor an environment or surroundings of a user. For example, Sensors 905 may comprise one or more cameras, video cameras, or the like, that are directed externally to the user. In some exemplary embodiments. Sensors 905 may comprise one or more sensors that are configured to track and monitor an attention focus, state, or context of a user. For example. Sensors 905 may comprise driver-monitoring sensors, an eye-tracker, a microphone, a driver-facing camera, or the like.

The components detailed below may be implemented as one or more sets of interrelated computer instructions, executed for example by Processor 902 or by another processor. The components may be arranged as one or more executable files, dynamic libraries, static libraries, methods, functions, services, or the like, programmed in any programming language and under any computing environment.

In some exemplary embodiments, Hazard Monitor 910 may be configured to obtain sensor information from a plurality of sensors monitoring the environment of a user. e.g., via I/O Module 903 or via any other component or device. Hazard Monitor 910 may obtain the sensor information from video sensors, cameras, processors, components, or sensors that are embedded in a vehicle that a user is driving, added-on sensors that are placed inside the vehicle, added-on sensors that are attached to an external wall of the vehicle, or the like.

In some exemplary embodiments. Hazard Monitor 910 may utilize one or more object recognition techniques in order to identify one or more objects in the user's environment, and utilize one or more classifiers in order to estimate whether an identified object can be classified as a hazard to the user.

In some exemplary embodiments, Risk Determinator 920 may be configured to estimate a risk kevel that is posed to the user from an object that is classified as a hazard by Hazard Monitor 910. In some exemplary embodiments, Risk Determinator 920 may determine a probability that the hazard will collide with the vehicle or cause harm to the user in any way. In some exemplary embodiments, in determining the risk, Risk Determinator 920 may consider sensor information associated with one or more hazards, sensor information associated with the user, or the like, e.g., which may be obtained from Sensors 905, as well as information from Profile 915. In some exemplary embodiments, Risk Determinator 920 may estimate a probability that the hazard is a risk, a danger level that is estimated to be posed by the hazard, an urgency of the situation, or the like, and determine a risk level based thereon. The risk el may be represented as a percentage between 0 and 100, as a value from a defined range, or the like.

In some exemplary embodiments, Stimuli Determinator 930 may be configured to map determine for each hazard a stimuli configuration based on the risk level of the hazard. Stimuli Determinator 930 may configure attributes of a stimuli to be more prominent when the risk level is higher, and to be less prominent when the risk kevel is lower. For example, for a hazard with a determined risk level below a determined threshold, e.g., 33%, a single vector of motion may be configured as the stimuli, while for a hazard with a determined risk level above a determined threshold, e.g., 93%, three vectors of motion with high light intensity and large diameters may be configured as the stimuli.

In some exemplary embodiments. Stimuli Displayer 940 may be configured to display stimuli to the user according to the stimuli configuration. In some exemplary embodiments, Stimuli Displayer 940 may be configured to generate one or more arrays of light dots or light lines according to configurations of the stimuli configuration.

In some exemplary embodiments. Risk Determinator 920 may be configured to re-estimate the risk level periodically, upon identifying events at Hazard Monitor 910, or the like. In some exemplary embodiments. Stimuli Determinator 930 may re-adjust the stimuli configuration upon any change in a risk level.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., fight pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
based on sensor information, identifying a hazard in an environment of a user;
determining a risk level of the hazard to the user;
based on the risk level, determining a stimuli configuration for presenting stimuli to the user, wherein the stimuli configuration defines a vector of motion having a location and a direction, wherein the location and the direction are determined based on a relative location of the hazard with respect to the user, wherein attributes of the stimuli are determined based on the risk level; and
implementing the stimuli configuration, wherein said implementing comprises presenting the stimuli to the user.

2. The method of claim 1, wherein the user is a driver of a vehicle, wherein the sensor information is obtained from sensors of the vehicle wherein the risk level indicates a probability of an accident of the vehicle in view of the hazard.

3. The method of claim 1, wherein one or more objects in the environment of the user separate between the vector of motion and the hazard.

4. The method of claim 3, wherein the one or more objects comprise at least one car.

5. The method of claim 1, wherein the vector of motion comprises an array of lit dots or lit lines.

6. The method of claim 1, wherein the sensor information is obtained from sensors that are configured to monitor the user, wherein said determining the risk level of the hazard is performed based on information obtained by monitoring the user.

7. The method of claim 1 further comprising:
monitoring a focus of attention of the user, and
wherein said determining the stimuli configuration is further based on the focus of attention of the user.

8. The method of claim 7 further comprising:
determining that the focus of attention of the user is directed to a focus location in a windshield; and
wherein the location of the stimuli is determined also based on the focus location in the windshield.

9. The method of claim 1 further comprising:
monitoring the user during said implementing; and
in response to identifying that said implementing has failed to induce a desired response from the user, adjusting the stimuli configuration to increase a saliency of the stimuli, and re-implementing the adjusted stimuli.

10. The method of claim 1, wherein the stimuli configuration defines a second vector of motion that has a second direction, wherein the direction of the vector of motion and the second direction of the second vector of motion converge to an estimated location of the hazard.

11. The method of claim 10, wherein a first distance between the vector of motion and the hazard is different from a second distance between the second vector of motion and the hazard.

12. The method of claim 1 further comprising:
detecting a field of view of the user, whereby determining a peripheral visual field of the user;
wherein the attributes of the stimuli are determined based on whether the hazard is located at the peripheral visual field.

13. The method of claim 1 further comprising:
detecting a field of view of the user, wherein the field of view comprises a first visual field from which the hazard cannot be perceived; and
presenting an additional stimuli that can be perceived by the user in the first visual field, wherein the additional stimuli is configured to direct attention of the user to a second visual field, wherein the vector of motion can be perceived in the second visual field.

14. The method of claim 1 further comprising:
adjusting the risk level of the hazard to a second risk level, wherein the second risk level is different from the risk level;
in response to said adjusting, determining a second stimuli configuration for presenting the stimuli to the user, wherein the second stimuli configuration is different from the stimuli configuration; and
implementing the second stimuli configuration.

15. The method of claim 1 further comprising:
determining a second risk level of a second hazard, wherein the risk level is different from the second risk level; and
in response to said determining the second risk level, determining a second stimuli configuration for presenting a second stimuli to the user, wherein the second stimuli configuration is different from the stimuli configuration.

16. A computer program product comprising a non-transitory computer readable storage medium retaining program instructions, which program instructions when read by a processor, cause the processor to:
based on sensor information, identify a hazard in an environment of a user;
determine a risk level of the hazard to the user;
based on the risk level, determine a stimuli configuration for presenting stimuli to the user, wherein the stimuli configuration defines a vector of motion having a location and a direction, wherein the location and the direction are determined based on a relative location of the hazard with respect to the user, wherein attributes of the stimuli are determined based on the risk level; and
implement the stimuli configuration, wherein said implement comprises presenting the stimuli to the user.

17. The computer program product of claim 16, wherein the vector of motion comprises an array of lit dots or lit lines.

18. The computer program product of claim 16, wherein the stimuli configuration is not configured to present the stimuli in more than three sides of the hazard.

19. The computer program product of claim 16, wherein the attributes of the stimuli comprise at least one of the group consisting of:
a duration of presenting the stimuli;
a size of the stimuli;
a color of the stimuli;
a saliency of the stimuli;
a transparency level of the stimuli;
a speed of motion of the stimuli;
a length of the vector of motion;
a distance between the stimuli and the hazard; and
a position of the stimuli.

20. A system comprising a processor and coupled memory, the processor being adapted to:
based on sensor information, identify a hazard in an environment of a user;
determine a risk level of the hazard to the user;
based on the risk level, determine a stimuli configuration for presenting stimuli to the user, wherein the stimuli configuration defines a vector of notion having a location and a direction, wherein the location and the direction are determined based on a relative location of the hazard with respect to the user, wherein attributes of the stimuli are determined based on the risk level; and
implement the stimuli configuration, wherein said implement comprises presenting the stimuli to the user.
